(19) United States
(12) Patent Application Publication
(10) Pub. No.: US 2015/0275040 A1
(43) Pub. Date: Oct. 1, 2015

(54) RADIATION-CURABLE HARD-COAT COMPOSITION

(71) Applicant: Uni-Pixel Displays, Inc., The Woodlands, TX (US)

(72) Inventors: Zhengwei Shi, Spring, TX (US); Danliang Jin, The Woodlands, TX (US); Robert J. Petcavich, The Woodlands, TX (US); Xuanqi Zhang, Spring, TX (US)

(21) Appl. No.: 14/727,789

(22) Filed: Jun. 1, 2015

Related U.S. Application Data
(63) Continuation-in-part of application No. 14/354,507, filed on Aug. 5, 2014.
Application No. 14/354,507 is a continuation-in-part of application No. 14/354,526, filed on Apr. 25, 2014.
(60) Provisional application No. 61/551,009, filed on Oct. 25, 2011.
(60) Provisional application No. 61/551,030, filed on Oct. 25, 2011.

(51) Int. Cl. C09D 175/14; C09D 167/00; C09D 133/00; C09D 171/00; G06F 3/041; C09D 163/10

(52) U.S. Cl. CPC C09D 175/14; G06F 3/041; C09D 163/10; C09D 133/00; C09D 171/00; C09D 167/00; G06F 2203/04103; G06F 2203/04107

(57) ABSTRACT

A radiation-curable hard-coat composition includes a principal resin that includes multi-(meth)acrylate functionalized oligomers or polymers and a free radical-polymerization initiator. The initiator includes at least two photo-initiators in a predetermined ratio that generate a highly reactive species when irradiated with radiation.

### CROSS-REFRENCE TO RELATED APPLICATIONS

This application is a continuation-in-part of U.S. patent application Ser. No. 14/354,507, filed on Aug. 5, 2014, which is a national phase entry of PCT International Application PCT/US2012/042050, filed on Jun. 12, 2012, which claims the benefit of, or priority to, U.S. Provisional Patent Application Ser. No. 61/551,009, filed on Oct. 25, 2011, and is also a continuation-in-part of U.S. patent application Ser. No. 14/354,526, filed on Apr. 25, 2014, which is a national phase entry of PCT International Application PCT/US2012/061602, filed on Oct. 24, 2012, which claims the benefit of, or priority to, U.S. Provisional Patent Application Ser. No. 61/551,030, filed on Oct. 25, 2011, all of which are hereby incorporated by reference in their entirety.

### BACKGROUND OF THE INVENTION

Touch screens are commonly found in consumer, commercial, and industrial systems. A touch screen allows a user to control various aspects of a system by touch or gestures directly on the touch screen itself For example, a user may interact with one or more objects depicted on a display device by touch or gestures that are sensed by a touch sensor. Typically, the touch sensor includes a conductive pattern disposed on a substrate that is configured to sense touch. Touch sensors are prone to damage such as, for example, scratching and breakage, due to the increased level of direct contact. As a consequence, touch screens typically include a transparent cover lens that overlays the touch sensor to protect the underlying components from environmental conditions, chemical agents, abrasion, and oxidation.

However, the transparent cover lens is conventionally composed of polyester or glass. While flexible, polyester can only provide a minimal level of hardness. For example, a transparent cover lens composed of polyester provides a pencil hardness in a range between HB and 4H that is susceptible to scratching and other failure modes. Glass provides improved hardness at the expense of flexibility. For example, a transparent cover lens composed of glass provides increased pencil hardness compared to polyester, but is inflexible and is susceptible to breakage and other failure modes.

### BRIEF SUMMARY OF THE INVENTION

According to one aspect of one or more embodiments of the present invention, a radiation-curable hard-coat composition includes a principal resin that includes multi-(meth)acrylate functionalized oligomers or polymers and a free radical-polymerization initiator. The initiator includes at least two photo-initiators in a predetermined ratio that generate a highly reactive species when irradiated with radiation.

Other aspects of the present invention will be apparent from the following description and claims.

### BRIEF DESCRIPTION OF THE DRAWINGS

FIG. 1A shows a cross section of a conventional touch screen.

FIG. 1B shows a cross section of a touch screen in accordance with one or more embodiments of the present invention.

FIG. 2 shows a schematic view of a touch screen enabled system in accordance with one or more embodiments of the present invention.

FIG. 3 shows a functional representation of a touch sensor as part of a touch screen in accordance with one or more embodiments of the present invention.

FIG. 4 shows a cross-section of a touch sensor with conductive patterns disposed on opposing sides of a transparent substrate in accordance with one or more embodiments of the present invention.

FIG. 5A shows a first conductive pattern disposed on a transparent substrate in accordance with one or more embodiments of the present invention.

FIG. 5B shows a second conductive pattern disposed on a transparent substrate in accordance with one or more embodiments of the present invention.

FIG. 5C shows a mesh area of a touch sensor in accordance with one or more embodiments of the present invention.

FIG. 6 shows common commercially-available UV lamps and their spectral outputs in accordance with one or more embodiments of the present invention.

FIG. 7 shows the photo-initiation efficiency of a radiation-curable hard-coat composition with different multi-constituent photo-initiator content in accordance with one or more embodiments of the present invention.

### DETAILED DESCRIPTION OF THE INVENTION

One or more embodiments of the present invention are described in detail with reference to the accompanying figures. For consistency, like elements in the various figures are denoted by like reference numerals. In the following detailed description of the present invention, specific details are set forth in order to provide a thorough understanding of the present invention. In other instances, well-known features to one of ordinary skill in the art are not described to avoid obscuring the description of the present invention.

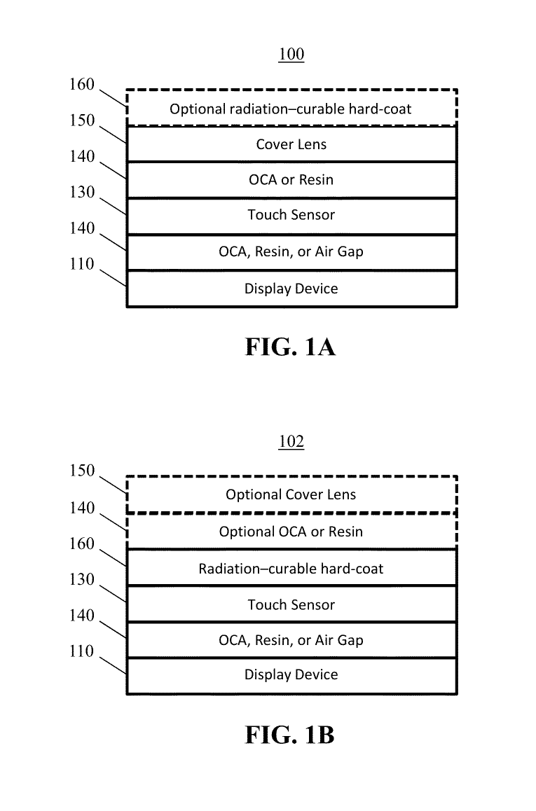

FIG. 1A shows a cross-section of a conventional touch screen 100. Touch screen 100 includes a display device 110 and a touch sensor 130 that overlays a viewable area of display device 110. Touch sensor 130 may be a capacitive, resistive, optical, acoustic, or any other type of touch sensor technology capable of sensing touch. In certain applications, an optically clear adhesive (“OCA”) or optically clear resin (“OCR”) 140 bonds a bottom side of touch sensor 130 to a top, or user-facing, side of display device 110. In other applications, an isolation layer, or air gap, 140 separates the bottom side of touch sensor 130 from the top, or user-facing, side of display device 110. A transparent cover lens 150 overlays a top, or user-facing, side of touch sensor 130. The transparent cover lens 150 is composed of transparent polymers or glass. In certain applications, an OCA or OCR 140 bonds a bottom side of the transparent cover lens 150 to the top, or user-facing, side of touch sensor 130. A top side of transparent cover lens 150 faces the user and protects the underlying components of touch screen 100. In certain applications, touch sensor 130, or the function that it implements, may be integrated into the display device 110 stack (not independently illustrated).

In one or more embodiments of the present invention, a radiation-curable hard-coat 160 may be used on a top, or user-facing side, of transparent cover lens (e.g., 150 of FIG. 1A). In certain embodiments, radiation-curable hard-coat 160 may be applied directly to the top, or user-facing, side of a transparent cover lens (e.g., 150 of FIG. 1A). In this way, the top, or user-facing, side of radiation-curable hard-coat 160 serves as the interface between touch screen 102 and the end user.

FIG. 1B shows a cross-section of a touch screen 102 in accordance with one or more embodiments of the present invention. Touch screen 102 includes a display device 110. Display device 110 may be a Liquid Crystal Display (“LCD”), Light-Emitting Diode (“LED”), Organic Light-Emitting Diode (“OLED”), Active Matrix Organic Light-Emitting Diode (“AMOLED”), In-Plane Switching (“IPS”), or other type of display device suitable for use as part of a touch screen application or design. In one or more embodiments of the present invention, touch screen 102 may include a touch sensor 130 that overlays at least a portion of a viewable area of display device 110. The viewable area of display device 110 may include the area defined by the light emitting pixels (not shown) of the display device 110 that are viewable to an end user. In certain embodiments, an OCA or OCR 140 may bond a bottom side of touch sensor 130 to a top, or user-facing, side of display device 110. In other embodiments, an isolation layer, or air gap, 140 may separate the bottom side of touch sensor 130 from the top, or user-facing, side of display device 110.

In one or more embodiments of the present invention, a radiation-curable hard-coat 160 may be used instead of a transparent cover lens (e.g., 150 of FIG. 1A). In certain embodiments, radiation-curable hard-coat 160 may be applied directly to the top, or user-facing, side of touch sensor 130 in lieu of a bonding layer (e.g., 140 of FIG. 1A) and a transparent cover lens (e.g., 150 of FIG. 1A). In this way, the top, or user-facing, side of radiation-curable hard-coat 160 serves as the interface between touch screen 102 and the end user. In other embodiments, radiation-curable hard-coat 160 may be used to protect touch sensor 130 and an optional bonding layer 140 and/or an optional transparent cover lens 150 may be used. Touch sensor 130 may be a capacitive, resistive, optical, acoustic, or any other type of touch sensor technology capable of sensing touch. One of ordinary skill in the art will recognize that touch sensor 130, or the function that it implements, may be integrated into the display device 110 stack (not independently illustrated). One of ordinary skill in the art will also recognize that the components and/or the stackup of touch screen 102 may vary based on an application or design.

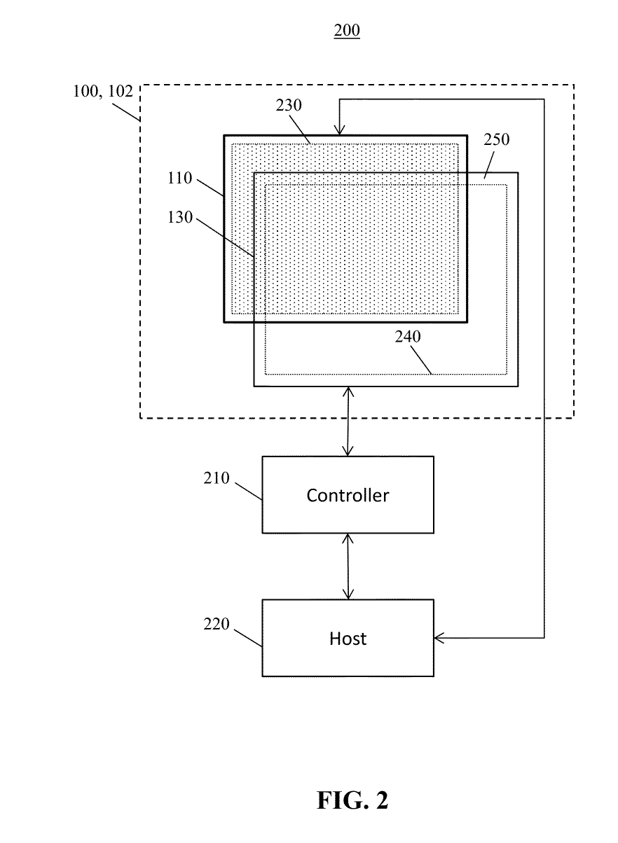

FIG. 2 shows a schematic view of a touch screen enabled system 200 in accordance with one or more embodiments of the present invention. Touch screen enabled system 200 may be a consumer, commercial, or industrial system including, but not limited to, a smartphone, tablet computer, laptop computer, desktop computer, server computer, printer, monitor, television, appliance, application specific device, kiosk, automatic teller machine, copier, desktop phone, automotive display system, portable gaming device, gaming console, or other application or design suitable for use with touch screen 100 or 102.

Touch screen enabled system 200 may include one or more printed circuit boards or flexible circuits (not shown) on which one or more processors (not shown), system memory (not shown), and other system components (not shown) may be disposed. Each of the one or more processors may be a single-core processor (not shown) or a multi-core processor (not shown) capable of executing software instructions. Multi-core processors typically include a plurality of processor cores disposed on the same physical die (not shown) or a plurality of processor cores disposed on multiple die (not shown) disposed within the same mechanical package (not shown). System 200 may include one or more input/output devices (not shown), one or more local storage devices (not shown) including solid-state memory, a fixed disk drive, a fixed disk drive array, or any other non-transitory computer readable medium, a network interface device (not shown), and/or one or more network storage devices (not shown) including a network-attached storage device or a cloud-based storage device.

In certain embodiments, touch screen 100 or 102 may include touch sensor 130 that overlays at least a portion of a viewable area 230 of display device 110. Touch sensor 130 may include a viewable area 240 that corresponds to that portion of the touch sensor 130 that overlays the light emitting pixels (not shown) of display device 110 (e.g., viewable area 230 of display device 110). Touch sensor 130 may include a bezel circuit 250 outside at least one side of the viewable area 240 that provides connectivity between touch sensor 130 and a controller 210. In other embodiments, touch sensor 130, or the function that it implements, may be integrated into display device 110 (not independently illustrated). Controller 210 electrically drives at least a portion of touch sensor 130. Touch sensor 130 senses touch (capacitance, resistance, optical, acoustic, or other technology) and conveys information corresponding to the sensed touch to controller 210.

The manner in which the sensing of touch is measured, tuned, and/or filtered may be configured by controller 210. In addition, controller 210 may recognize one or more gestures based on the sensed touch or touches. Controller 210 provides host 220 with touch or gesture information corresponding to the sensed touch or touches. Host 220 may use this touch or gesture information as user input and respond in an appropriate manner. In this way, the user may interact with touch screen enabled system 200 by touch or gestures on touch screen 100 or 102. In certain embodiments, host 220 may be the one or more printed circuit boards (not shown) or flexible circuits (not shown) on which the one or more processors (not shown) are disposed. In other embodiments, host 220 may be a subsystem (not shown) or any other part of system 200 (not shown) that is configured to interface with display device 110 and controller 210. One of ordinary skill in the art will recognize that the components and the configuration of the components of touch screen enabled system 200 may vary based on an application or design in accordance with one or more embodiments of the present invention.

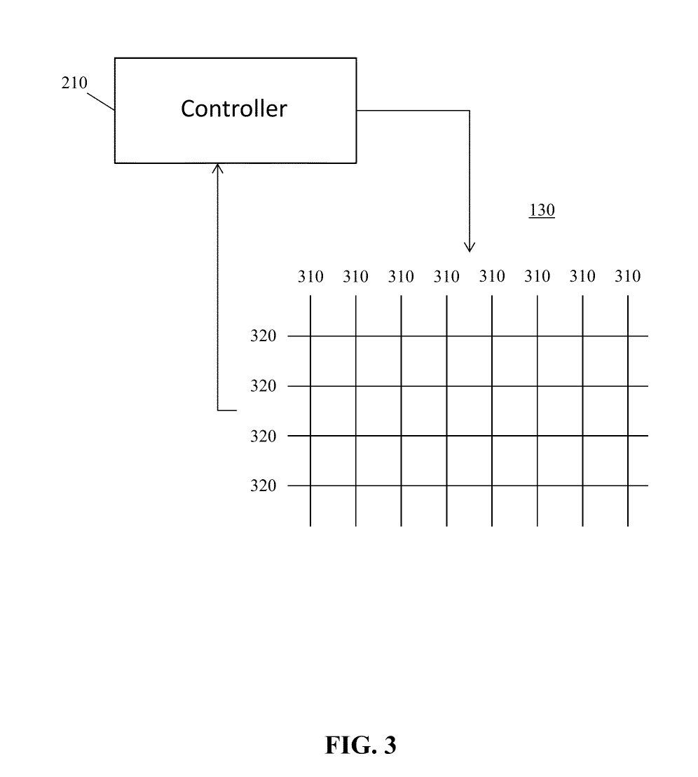

FIG. 3 shows a functional representation of a touch sensor 130 as part of a touch screen 100 or 102 in accordance with one or more embodiments of the present invention. In certain embodiments, touch sensor 130 may be viewed as a plurality of column channels 310 and a plurality of row channels 320. The plurality of column channels 310 and the plurality of row channels 320 may be separated from one another by, for example, a dielectric or substrate (not shown) on which they are disposed. The number of column channels 310 and the number of row channels 320 may or may not be the same and may vary based on an application or a design. The apparent intersections of column channels 310 and row channels 320 may be viewed as uniquely addressable locations of touch sensor 130. In operation, controller 210 may electrically drive one or more row channels 320 and touch sensor 130 may sense touch on one or more column channels 310 that are sampled by controller 210. One of ordinary skill in the art will recognize that the role of row channels 320 and column channels 310 may be reversed such that controller 210 electrically drives one or more column channels 310 and touch sensor 130 senses touch on one or more row channels 320 that are sampled by controller 210.

In certain embodiments, controller 210 may interface with touch sensor 130 by a scanning process. In such an embodiment, controller 210 may electrically drive a selected row channel 320 (or column channel 310) and sample all column channels 310 (or row channels 320) that intersect the selected row channel 320 (or the selected column channel 310) by sensing, for example, changes in capacitance. The change in capacitance may be used to determine the location of the touch or touches. This process may be continued through all row channels 320 (or all column channels 310) such that changes in capacitance are measured at each uniquely addressable location of touch sensor 130 at predetermined intervals. Controller 210 may allow for the adjustment of the scan rate depending on the needs of a particular application or design. In other embodiments, controller 210 may interface with touch sensor 130 by an interrupt driven process. In such an embodiment, a touch or a gesture generates an interrupt to controller 210 that triggers controller 210 to read one or more of its own registers that store sensed touch information sampled from touch sensor 130 at predetermined intervals. One of ordinary skill in the art will recognize that the mechanism by which touch or gestures are sensed by touch sensor 130 and sampled by controller 210 may vary based on an application or a design in accordance with one or more embodiments of the present invention.

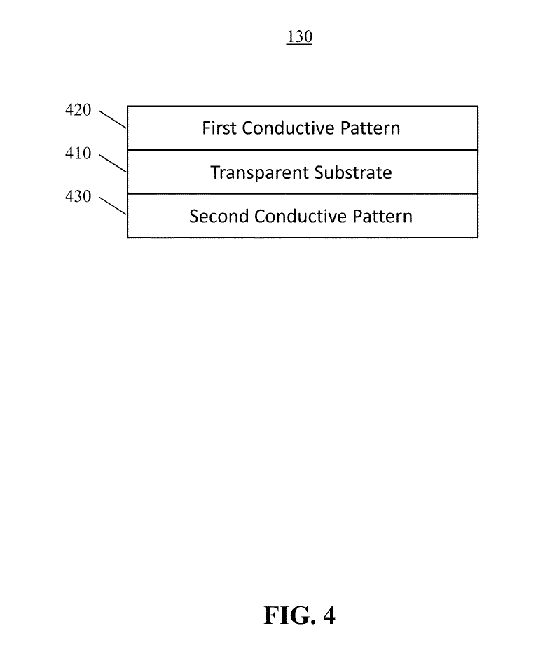

FIG. 4 shows a cross-section of a touch sensor 130 with conductive patterns 420 and 430 disposed on opposing sides of a transparent substrate 410 in accordance with one or more embodiments of the present invention. In certain embodiments, touch sensor 130 may include a first conductive pattern 420 disposed on a top, or user-facing, side of a transparent substrate 410 and a second conductive pattern 430 disposed on a bottom side of the transparent substrate 410. The first conductive pattern 420 may overlay the second conductive pattern 430 at a predetermined alignment that may include an offset. One of ordinary skill in the art will recognize that a conductive pattern may be any shape or pattern of one or more conductors (not shown) in accordance with one or more embodiments of the present invention. One of ordinary skill in the art will also recognize that any type of touch sensor 130 conductor, including, for example, metal conductors, metal mesh conductors, indium tin oxide (“ITO”) conductors, poly(3,4-ethylenedioxythiophene (“PEDOT”) conductors, carbon nanotube conductors, silver nanowire conductors, or any other conductors may be used in accordance with one or more embodiments of the present invention.

One of ordinary skill in the art will recognize that other touch sensor 130 stackups (not shown) may be used in accordance with one or more embodiments of the present invention. For example, single-sided touch sensor 130 stackups may include conductors disposed on a single side of a substrate 410 where conductors that cross are isolated from one another by a dielectric material (not shown), such as, for example, as used in On Glass Solution (“OGS”) touch sensor 130 embodiments. Double-sided touch sensor 130 stackups may include conductors disposed on opposing sides of the same substrate 140 (as shown in FIG. 4) or bonded touch sensor 130 embodiments (not shown) where conductors are disposed on at least two different sides of at least two different substrates 410. Bonded touch sensor 130 stackups may include, for example, two single-sided substrates 410 bonded together (not shown), one double-sided substrate 410 bonded to a single-sided substrate 410 (not shown), or a double-sided substrate 410 bonded to another double-sided substrate 410 (not shown). One of ordinary skill in the art will recognize that other touch sensor 130 stackups, including those that vary in the number, type, organization, and/or configuration of substrate(s) and/or conductive pattern(s) are within the scope of one or more embodiments of the present invention. One of ordinary skill in the art will also recognize that one or more of the above-noted touch sensor 130 stackups may be used in applications where touch sensor 130 is integrated into display device 110.

A conductive pattern 420 or 430 may be disposed on one or more transparent substrates 410 by any process suitable for disposing conductive lines or features on a substrate. Suitable processes may include, for example, printing processes, vacuum-based deposition processes, solution coating processes, or cure/etch processes that either form conductive lines or features on substrate or form seed lines or features on substrate that may be further processed to form conductive lines or features on substrate. Printing processes may include flexographic printing processes, including the flexographic printing of a catalytic ink that may be metallized by an electroless plating process to plate a metal on top of the printed catalytic ink or direct flexographic printing of conductive ink or other materials capable of being flexographically printed, gravure printing, inkjet printing, rotary printing, or stamp printing. Deposition processes may include pattern-based deposition, chemical vapor deposition, electro deposition, epitaxy, physical vapor deposition, or casting. Cure/etch processes may include optical or Ultra-Violet (“UV”)-based photolithography, e-beam/ion-beam lithography, x-ray lithography, interference lithography, scanning probe lithography, imprint lithography, or magneto lithography. One of ordinary skill in the art will recognize that any process or combination of processes, suitable for disposing conductive lines or features on substrate, may be used in accordance with one or more embodiments of the present invention.

With respect to transparent substrate 410, transparent means capable of transmitting a substantial portion of visible light through the substrate suitable for a given touch sensor application or design. In typical touch sensor applications, transparent means transmittance of at least 85 percent of incident visible light through the substrate. However, one of ordinary skill in the art will recognize that other transmittance values may be desirable for other touch sensor applications or designs. In certain embodiments, transparent substrate 410 may be polyethylene terephthalate (“PET”), polyethylene naphthalate (“PEN”), cellulose acetate (“TAC”), cycloaliphatic hydrocarbons (“COP”), polymethylmethacrylates (“PMMA”), polyimide (“PI”), bi-axially-oriented polypropylene (“BOPP”), polyester, polycarbonate, glass, copolymers, blends, or combinations thereof. In other embodiments, transparent substrate 410 may be any other transparent material suitable for use as a touch sensor substrate. One of ordinary skill in the art will recognize that the composition of transparent substrate 410 may vary based on an application or design in accordance with one or more embodiments of the present invention.

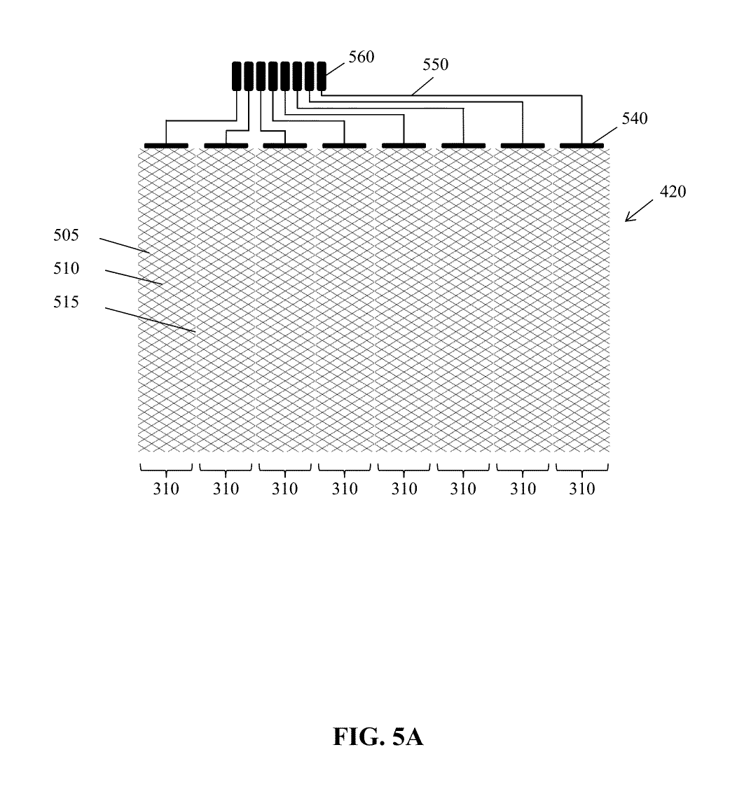

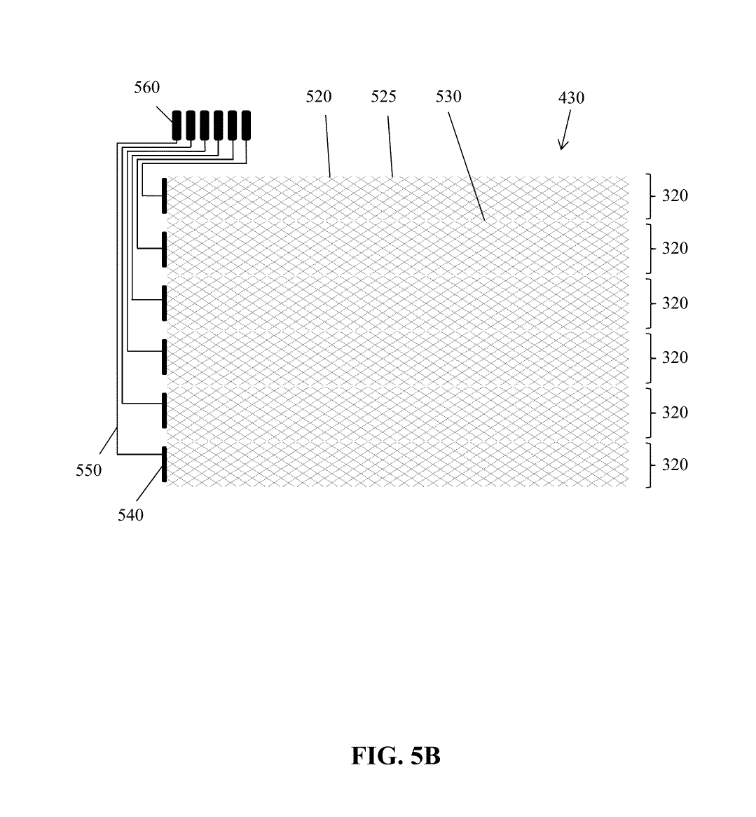

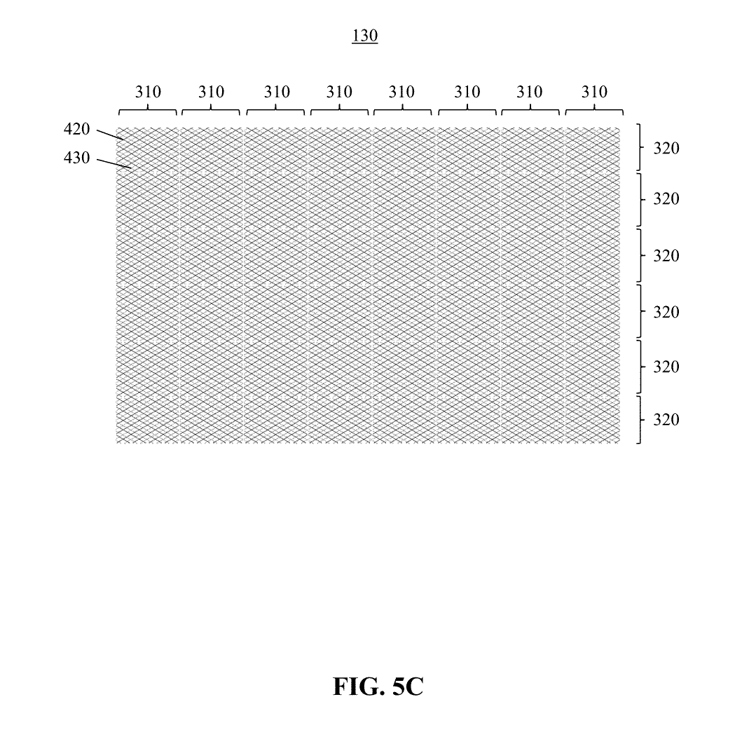

FIG. 5A shows a first conductive pattern 420 disposed on a transparent substrate (e.g., transparent substrate 410) in accordance with one or more embodiments of the present invention. In certain embodiments, first conductive pattern 420 may include a mesh formed by a first plurality of parallel conductive lines oriented in a first direction 505 and a first plurality of parallel conductive lines oriented in a second direction 510 that are disposed on a side of a transparent substrate (e.g., transparent substrate 410). One of ordinary skill in the art will recognize that the number of parallel conductive lines oriented in the first direction 505 and/or the number of parallel conductive lines oriented in the second direction 510 may or may not be the same and may vary based on an application or design. One of ordinary skill in the art will also recognize that a size of first conductive pattern 420 may vary based on an application or a design. In other embodiments, first conductive pattern 420 may include any other shape or pattern formed by one or more conductive lines or features (not independently illustrated). One of ordinary skill in the art will recognize that first conductive pattern 420 is not limited to parallel conductive lines and may comprise any one or more of a predetermined orientation of line segments, a random orientation of line segments, curved line segments, conductive particles, polygons, or any other shape(s) or pattern(s) comprised of electrically conductive material (not independently illustrated) in accordance with one or more embodiments of the present invention.

In certain embodiments, the first plurality of parallel conductive lines oriented in the first direction 505 may be perpendicular (not shown) to the first plurality of parallel conductive lines oriented in the second direction 510, thereby forming a rectangle-type mesh (not shown). In other embodiments, the first plurality of parallel conductive lines oriented in the first direction 505 may be angled relative to the first plurality of parallel conductive lines oriented in the second direction 510, thereby forming a parallelogram-type mesh. One of ordinary skill in the art will recognize that the relative angle between the first plurality of parallel conductive lines oriented in the first direction 505 and the first plurality of parallel conductive lines oriented in the second direction 510 may vary based on an application or a design in accordance with one or more embodiments of the present invention.

In certain embodiments, a first plurality of channel breaks 515 may partition first conductive pattern 420 into a plurality of column channels 310, each electrically isolated from the others (no electrical continuity). One of ordinary skill in the art will recognize that the number of channel breaks 515, the number of column channels 310, and/or the width of the column channels 310 may vary based on an application or design in accordance with one or more embodiments of the present invention. Each column channel 310 may route to a channel pad 540. Each channel pad 540 may route via one or more interconnect conductive lines 550 to an interface connector 560. Interface connectors 560 may provide a connection interface between a touch sensor (e.g., 130 of FIG. 2) and a controller (e.g., 210 of FIG. 2).

FIG. 5B shows a second conductive pattern 430 disposed on a transparent substrate (e.g., transparent substrate 410) in accordance with one or more embodiments of the present invention. In certain embodiments, second conductive pattern 430 may include a mesh formed by a second plurality of parallel conductive lines oriented in a first direction 520 and a second plurality of parallel conductive lines oriented in a second direction 525 that are disposed on a side of a transparent substrate (e.g., transparent substrate 410). One of ordinary skill in the art will recognize that the number of parallel conductive lines oriented in the first direction 520 and/or the number of parallel conductive lines oriented in the second direction 525 may vary based on an application or design. The second conductive pattern 430 may be substantially similar in size to the first conductive pattern 420. One of ordinary skill in the art will recognize that a size of the second conductive pattern 430 may vary based on an application or a design. In other embodiments, second conductive pattern 430 may include any other shape or pattern formed by one or more conductive lines or features (not independently illustrated). One of ordinary skill in the art will also recognize that second conductive pattern 430 is not limited to parallel conductive lines and could be any one or more of a predetermined orientation of line segments, a random orientation of line segments, curved line segments, conductive particles, polygons, or any other shape(s) or pattern(s) comprised of electrically conductive material (not independently illustrated) in accordance with one or more embodiments of the present invention.

In certain embodiments, the second plurality of parallel conductive lines oriented in the first direction 520 may be perpendicular (not shown) to the second plurality of parallel conductive lines oriented in the second direction 525, thereby forming a rectangle-type mesh (not shown). In other embodiments, the second plurality of parallel conductive lines oriented in the first direction 520 may be angled relative to the second plurality of parallel conductive lines oriented in the second direction 525, thereby forming a parallelogram-type mesh. One of ordinary skill in the art will recognize that the relative angle between the second plurality of parallel conductive lines oriented in the first direction 520 and the second plurality of parallel conductive lines oriented in the second direction 525 may vary based on an application or a design in accordance with one or more embodiments of the present invention.

In certain embodiments, a plurality of channel breaks 530 may partition second conductive pattern 430 into a plurality of row channels 320, each electrically isolated from the others (no electrical continuity). One of ordinary skill in the art will recognize that the number of channel breaks 530, the number of row channels 320, and/or the width of the row channels 320 may vary based on an application or design in accordance with one or more embodiments of the present invention. Each row channel 320 may route to a channel pad 540. Each channel pad 540 may route via one or more interconnect conductive lines 550 to an interface connector 560. Interface connectors 560 may provide a connection interface between a touch sensor (e.g., 130 of FIG. 2) and a controller (e.g., 210 of FIG. 2).

FIG. 5C shows a mesh area of a touch sensor 130 in accordance with one or more embodiments of the present invention. In certain embodiments, a touch sensor 130 may be formed, for example, by disposing a first conductive pattern 420 on a top, or user-facing, side of a transparent substrate (e.g., transparent substrate 410) and disposing a second conductive pattern 430 on a bottom side of the transparent substrate (e.g., transparent substrate 410). In other embodiments, a touch sensor 130 may be formed, for example, by disposing a first conductive pattern 420 on a side of a first transparent substrate (e.g., transparent substrate 410), disposing a second conductive pattern 430 on a side of a second transparent substrate (e.g., transparent substrate 410), and bonding the first transparent substrate to the second transparent substrate. One of ordinary skill in the art will recognize that the disposition of the conductive pattern or patterns may vary based on the touch sensor 130 stack up in accordance with one or more embodiments of the present invention. In embodiments that use two conductive patterns, the first conductive pattern 420 and the second conductive pattern 430 may be offset vertically, horizontally, and/or angularly relative to one another. The offset between the first conductive pattern 420 and the second conductive pattern 430 may vary based on an application or a design. One of ordinary skill in the art will recognize that the first conductive pattern 420 and the second conductive pattern 430 may be disposed on substrate or substrates 410 using any process or processes suitable for disposing the conductive patterns on the substrate or substrates 410 in accordance with one or more embodiments of the present invention.

In certain embodiments, the first conductive pattern 420 may include a first plurality of parallel conductive lines oriented in a first direction (e.g., 505 of FIG. 5A) and a first plurality of parallel conductive lines oriented in a second direction (e.g., 510 of FIG. 5A) that form a mesh that is partitioned by a first plurality of channel breaks (e.g., 515 of FIG. 5A) into electrically partitioned column channels 310. In certain embodiments, the second conductive pattern 430 may include a second plurality of parallel conductive lines oriented in a first direction (e.g., 520 of FIG. 5B) and a second plurality of parallel conductive lines oriented in a second direction (e.g., 525 of FIG. 5B) that form a mesh that is partitioned by a second plurality of channel breaks (e.g., 530 of FIG. 5B) into electrically partitioned row channels 320. In operation, a controller (e.g., 210 of FIG. 2) may electrically drive one or more row channels 320 (or column channels 310) and touch sensor 130 senses touch on one or more column channels 310 (or row channels 320). In other embodiments, the disposition and/or the role of the first conductive pattern 420 and the second conductive pattern 430 may be reversed.

In certain embodiments, one or more of the plurality of parallel conductive lines oriented in the first direction (e.g., 505 of FIG. 5A, 520 of FIG. 5B) and one or more of the plurality of parallel conductive lines oriented in the second direction (e.g., 510 of FIG. 5A, 525 of FIG. 5A) may have a line width that varies based on an application or design, including, for example, nanometer or micrometer-fine line widths. In addition, the number of parallel conductive lines oriented in the first direction (e.g., 505 of FIG. 5A, 520 of FIG. 5B), the number of parallel conductive lines oriented in the second direction (e.g., 510 of FIG. 5A, 525 of FIG. 5B), and the line-to-line spacing between them may vary based on an application or a design. One of ordinary skill in the art will recognize that the size, configuration, and design of each conductive pattern 420, 430 may vary based on an application or a design in accordance with one or more embodiments of the present invention. One of ordinary skill in the art will also recognize that touch sensor 130 depicted in FIG. 5C is illustrative but not limiting and that the size, shape, and design of the touch sensor 130 is such that there is substantial transmission of an image (not shown) of an underlying display device (e.g., 110 of FIG. 1) in actual use that is not shown in the drawing.

Conventional coating compositions for protective applications that require some measure of scratch and abrasion resistance typically employ a cross-linked polymer-based molecular structure. A cross-link is a bond, covalent or ionic, that links one monomer or polymer to another. Cross-linked polymer structures are linked together in a three-dimensional structure that increases the intermolecular forces, usually covalent bonds, within the polymer chains and limits polymeric chain relaxation. Compared to a linear polymer structure, where monomers with dual functional groups are joined together in a chain, the scratch resistance of a cross-linked polymer may be dictated by the cross-linking density. The cross-linking density refers to the percentage of cross-linked bonds within a given polymer.

While cross-linked polymer structures provide improved scratch resistance over linear polymer structures, the use of conventional coatings based on cross-linked polymer structures presents a number of issues that impede their effective use. Conventional coating compositions typically require a choice, or at least a compromise, between flexibility and hardness. In applications or designs that require a high degree of hardness for scratch resistance, the applied coating tends to be inflexible, brittle, and susceptible to breakage. Alternatively, in applications or designs that require a high degree of flexibility to resist breakage, the applied coating is prone to scratching. In addition, conventional coating compositions typically exhibit shrinkage after curing by, for example, exposure to radiation. In applications or designs that apply the coating to substrates with low mechanical strength, such as flexible PET substrates used in touch sensor applications, the shrinkage of the cured coating gives rise to undesirable curling of the flexible substrate.

In addition, conventional coating compositions are difficult to apply for a number of reasons. While a uniform and consistent coating may be obtained through a solution deposition process, crosslinked polymers cannot be dissolved in any solvent. As such, while it is desirable to apply the coating composition in a liquid state, it is necessary to form the high density of cross-linking after the curing process of the liquid coating composition to the substrate. Thus, the density of cross-linking is constrained by the effectiveness of the curing process after application of the coating to the substrate. Moreover, the application of conventional coating compositions may not be possible, or is at least made very difficult, using conventional solution-based application processes. This is due to the fact that cross-linked polymers cannot dissolve in any solvent and swell when placed in solvent. This is problematic because coating compositions typically have to be in a liquid state to allow molecules to move and react in an efficient manner. As such, conventional coating compositions require trade-offs in various properties that render the coating at least inefficient, at worst inoperable for their intended purpose, increase the difficulty and cost of manufacturing, and negatively impact yield.

To that end, UV-curable coating compositions, containing a (meth)acrylate compound as a principal resin, have been used as protective films because the cured coating provides some manner of transparency, mechanical strength, and scratch resistance. Conventionally, UV-curable coating compositions are composed of a cation radiation curable resin and a cation polymerization initiator which generates a cation when irradiated with UV radiation. In some cases, inorganic particles are included to increase the mechanical strength, pencil hardness, and scratch resistance. In contrast, radical-polymerization coating compositions have received less attention because they are difficult to process and cure. Specifically, in thin-film applications of UV-curable coating compositions, curing effectiveness is inhibited by the presence of oxygen and nitrogen sealing or the like may be required to cure at some level of effectiveness. While progress has been made in developing UV-curable coating compositions based on radical-polymerization mechanisms, a number of issues continue to impede their widespread adoption and use. For example, conventional UV-curable coating compositions based on radical-polymerization possess high internal stress due to the fast curing process and the high internal stress leads to lack of flexibility.

Accordingly, in one or more embodiments of the present invention, a radiation-curable hard-coat composition provides a transparent hard coat that provides well-balanced flexibility and hardness, a high degree of scratch and abrasion resistance, and improved adhesiveness, UV stability, and process-ability in a manufacturing environment, including, for example, touch sensor applications. The radiation-curable hard-coat composition facilitates all aspects of manufacturing including application, processing, and post-fabrication processing and improves yield while reducing costs.

In one or more embodiments of the present invention, a radiation-curable hard-coat composition is a coating that, when cured by radiation, forms a three-dimensional cross-linked network through a free-radical polymerization mechanism. The radiation-curable hard-coat composition includes a principal resin that includes multi-(meth)acrylate functionalized oligomers or polymers and a free radical-polymerization initiator, as a curing agent, that generates a highly reactive species when exposed to radiation. The photo-initiators contains multiple components including at least two curing agents in a predetermined ratio, such as, for example, one or more surface curing agents and one or more deep curing agents that improve curing efficiency and provide homogenous curing along the depth of the applied coating. In addition, a solvent may optionally be included that enables the manufacture of the radiation-curable hard-coat composition in a manner that is fast, efficient, and cost effective to apply, process, and process post-fabrication.

As the principal resin, a multi-(meth)acrylate functionalized oligomers or polymers resin may be used as a film-forming component, which imparts the basic properties of the cured coating. Compared to small molecules, oligomers or polymers are relatively large molecules which are obtained by chemically linking tens to thousands of relatively small molecules. Specifically, multi-(meth)acrylate functionalized oligomers or polymers typically have a molecular weight in a range between 500 and 20,000 and possess between 2 and 15 acrylate functional groups per molecule. As a result, a high degree of cross-linking may be achieved for improved hardness. The multi-(meth)acrylate functionalized oligomers or polymers may be derived from various chemical backbones, such as, for example, polyol, polyester, polyurethane, polyether, epoxies, and acrylics. In terms of molecular geometry, they may be linear or branched. Because of the skeleton of the resin backbone and the molecular geometry, these multi-(meth)acrylate functionalized oligomers or polymers are highly viscous liquids with a viscosity in a range between at least a few thousand centipoises and potentially greater than one million centipoises in a broad temperature window.

Pentaerithritol tetraacrylate(“PETA”) is a commonly used UV-curable resin because it provides a high degree of cross-linking in the cured coating due to the relatively large ratio of (meth)acrylate functionality over the molecular weight. As such, it has been employed for protective coatings in various applications, including display applications where it provides a high degree of scratch resistance. However, PETA resins exhibit significant volumetric shrinkage during curing due to its intrinsic molecular structure. This presents a number of issues including, for example, a high degree of undesirable curling and brittleness. In contrast, a radiation-curable hard-coat composition that includes multi-(meth)acrylate functionalized oligomers or polymers as a principal resin may use a limited amount of PETA, if it uses any at all, as a complimentary component to provide additional cross-linking density. Because of the unique molecular characteristics noted herein, the multi-(meth)acrylate functionalized oligomers or polymers exhibit a substantially smaller amount of shrinkage, less than 5 percent by volume, after radiation curing. As such, a low level of built-in stress is induced in the coating resulting in a small curling angle after radiation curing. In addition, because of the multi-functionality of the (meth)acrylate functionalized oligomers or polymers used, the cross-linking density is very high after curing. In one or more embodiments of the present invention, in a radiation-curable hard-coat composition, the principal resin content as a percentage of weight of the composition may be in a range between 5 percent and 96 percent.

The cross-linking density of cross-linked polymers may be dictated by the effectiveness of the radiation curing. As such, photo-initiators play a critically important role in a radiation-curable coating composition. A photo initiator is a compound especially added to a composition to convert absorbed light energy, UV radiation or visible light, or other radiation into chemical energy in the form of an initiating species, such as, for example, free radicals. The free radical-polymerization initiator of the radiation-curable hard-coat composition includes at least two photo-initiators that generate a free radical when irradiated with radiation to initiate polymerization. The photo-initiators may include, but are not limited to, acetophenone, anisoin, anthraquinone, anthraquinone-2-sulfonic acid, sodium salt monohydrate, (benzene) tricarbonylchromium, benzil, benzoin, benzoin ethyl ether, benzoin isobutyl ether, benzoin methyl ether, benzophenone, benzophenone/1-hydroxycyclohexyl phenyl ketone, 50/50 blend, 3,3′,4,4′-benzophenonetetracarboxylic dianhydride, 4-benzoylbiphenyl, 2-benzyl-2-(dimethylamino)-4′-morpholinobutyrophenone, 4,4′-bis(diethylamino)benzophenone, 4,4′-bis(dimethylamino)benzophenone, camphorquinone, 2-chlorothioxanthen-9-one, dibenzosuberenone, 2,2-diethoxyacetophenone, 4,4′-dihydroxybenzophenone, 2,2-dimethoxy-2-phenylacetophenone, 4-(dimethylamino)benzophenone, 4,4′-dimethylbenzil, 2,5-dimethylbenzophenone, 3,4-dimethylbenzophenone, diphenyl(2,4,6-trimethylbenzoyl)phosphine oxide/2-hydroxy-2-methylpropiophenone, 50/50 blend, 4′-ethoxyacetophenone, 2,4,6-trimethylbenzoyldiphenylphophine oxide, phenyl bis(2,4,6-trimethyl benzoyl)phosphine oxide, 2-ethylanthraquinone, ferrocene, 3′-hydroxyacetophenone, 4′-hydroxyacetophenone, 3-hydroxybenzophenone, 4-hydroxybenzophenone, 1-hydroxycyclohexyl phenyl ketone, 2-hydroxy-2-methylpropiophenone, 2-methylbenzophenone, 3-methylbenzophenone, methybenzoylformate, 2-methyl-4′-(methylthio)-2-morpholinopropiophenone, phenanthrenequinone, 4′-phenoxyacetophenone, and others.

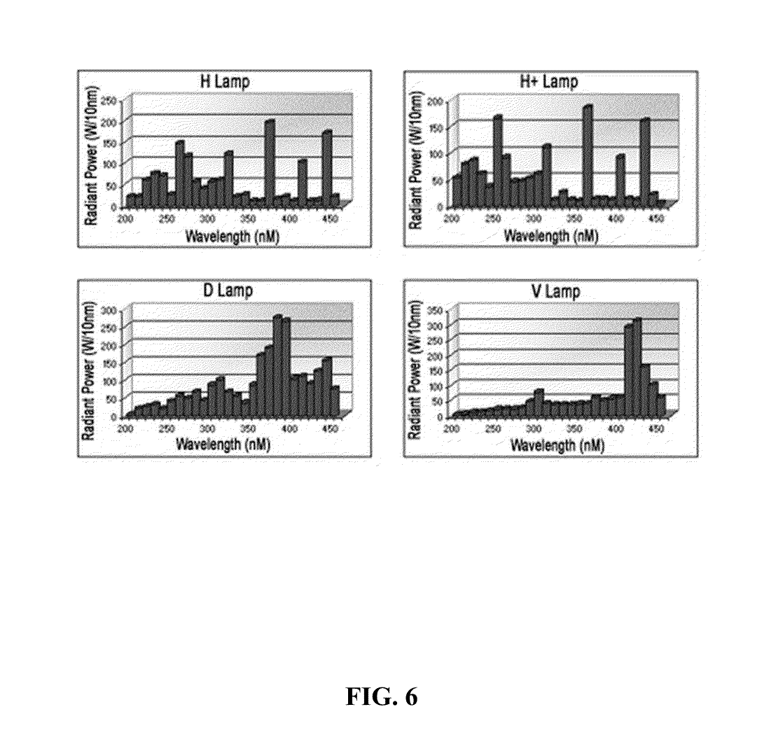

FIG. 6 shows common commercially-available UV lamps and their spectral outputs in accordance with one or more embodiments of the present invention. The H Lamp represents the conventional medium pressure mercury electrode-type lamp output (below 350 nanometers) while the V Lamp represents a significant shift to the visible region (above 400 nanometers). The D Lamp exhibits characteristics of both the H Lamp and the V Lamp. From a curing perspective, the D Lamp is often used to achieve a good curing depth while the H+ Lamp exhibits enhanced emission and shorter wavelengths, effective in promoting surface curing. The photo-initiator is an essential ingredient of radiation-curable coatings and has to have as much absorption as possible in the 200 nanometer to 480 nanometer range, in addition to other characteristics such as high reactivity and high thermal stability. Because of the intrinsic chemical structure of the radiation-curable hard-coat composition, any single photo initiator is not sufficient to cover a sufficiently broad spectrum range that provides sufficient energy absorption for efficient curing under a minimal irradiation dose. As such, instead of a mono-constituent photo-initiator, a combination of at least two photo-initiators, such as, for example, one for deep curing and another for surface curing, may be used to cover a larger or even the full radiation spectrum and provide efficient curing under a minimal irradiation dose.

In one or more embodiments of the present invention, in a radiation-curable hard-coat composition, the free radical-polymerization initiator content as a percentage of weight of the composition may be in a range between 0.5 percent and 8.0 percent, preferably in a range between 2.0 percent and 5.0 percent. Due to the spectral interference between different photo-initiators, the ratio of at least two combined photo-initiators has been quantitatively investigated and optimized with an overall photo-initiator content of 4.5 percent by weight of the composition. The samples were measured for curing characteristics in photo-assisted Differential Scanning Calorimetry (“DSC”) using DSC-Q2000 by TA Instruments. Light from a 100-W high pressure mercury lamp was used. The light intensity was determined by placing an empty DSC pan on the sample cell. The light intensity was 80 mW/cm² over a wavelength range between 320 nanometers and 500 nanometers. Photopolymerization was carried out at 25° C. in a nitrogen atmosphere.

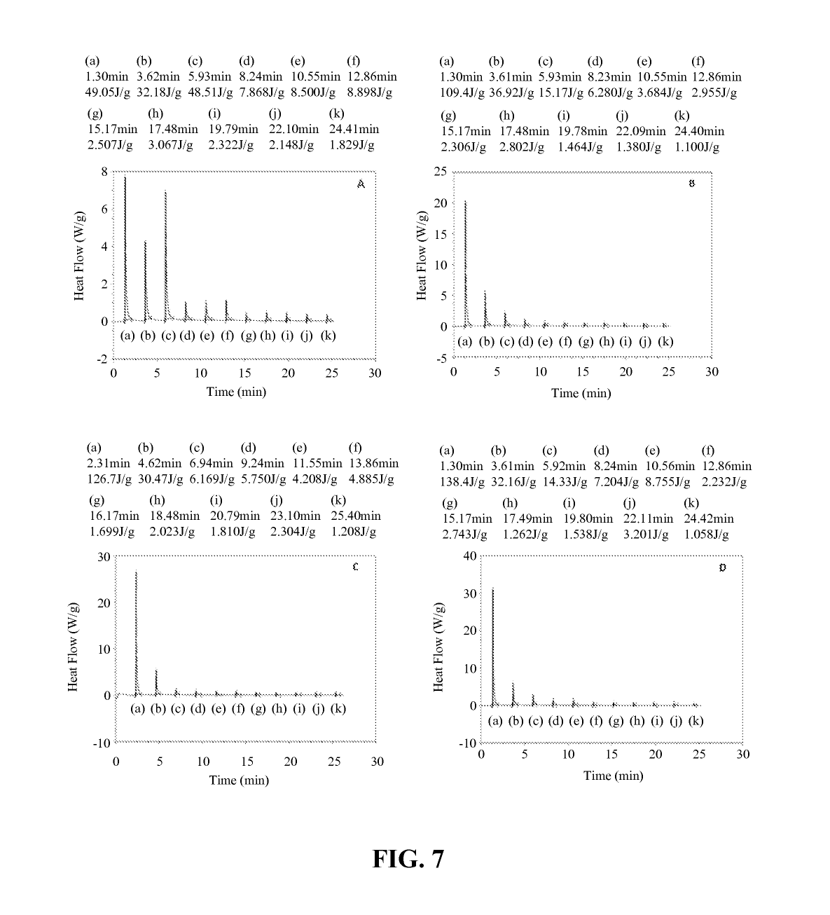

FIG. 7 shows the photo-initiation efficiency of a radiation-curable hard-coat composition with different free radical-polymerization initiator content (multi-constituent photo-initiator) in accordance with one or more embodiments of the present invention. In plot A, a radiation-curable hard-coat composition with free radical-polymerization initiator content of 4.5 percent by weight of the composition using only 1-hydroxycyclohexyl phenyl ketone is shown. In plot B, a radiation-curable hard-coat composition with free radical-polymerization initiator content of 4.5 percent by weight of the composition using a combination of 1-hydroxycyclohexyl phenyl ketone and diphenyl(2,4,6-trimethylbenzoyl)phosphine oxide in a ratio of 2 to 1 by weight is shown. In plot C, a radiation-curable hard-coat composition with free radical-polymerization initiator content of 4.5 percent by weight of the composition using a combination of 1-hydroxycyclohexyl phenyl ketone and diphenyl(2,4,6-trimethylbenzoyl)phosphine oxide in a ratio of 3 to 1 by weight is shown. In plot D, a radiation-curable hard-coat composition with free radical-polymerization initiator content of 4.5 percent by weight of the composition using a combination of 1-hydroxycyclohexyl phenyl ketone and diphenyl(2,4,6-trimethylbenzoyl)phosphine oxide in a ratio of 4 to 1 by weight is shown.

These plots show the enthalpy value and the curing time of the representative coating compositions. As shown in plot A, approximately 35 percent of the photo-initiator was consumed in the first irradiation cycle (0.6 seconds for each irradiation cycle) and two additional irradiation cycles were needed to initiate the curing agent up to 90 percent. As shown in plot B, there was an improvement in effectiveness of the curing in the first irradiation cycle as approximately 65 percent of photo-initiator was excited in the first irradiation cycles. This suggests that the use of multi-constituent photo-initiators may be more effective than a mono-constituent photo-initiator. As the ratio of diphenyl(2,4,6-trimethylbenzoyl)phosphine oxide was reduced, the photo-initiating efficiency improved to consume more than 80 percent of the photo-initiator in the first irradiation cycle as shown in plot C and plot D. This result suggests that absorption spectrum interference between different photo-initiators is an important criterion in designing a multi-constituent photo-initiator for efficient curing in a minimal irradiation dose. Thus, at least two different photo-initiators, such as, for example, one for deep curing and another for surface curing, may be combined to provide sufficient cross-linking efficiency under the same irradiation exposure. This is critically important in the case of thick films of hard coat having a thickness of 10 micrometers or more.

As discussed above, cross-linked polymer materials typically cannot be directly applied or coated onto a substrate or screen through a solution-based application process because the cross-linked polymers are not dissolvable in any solvent and only swell when placed in the solvent. Coating compositions are typically provided in the liquid state to allow the molecules to move and react more efficiently. However, in many applications, a solvent is employed in the coating compositions to provide a cost-effective solution process and other property adjustments including viscosity. In this regard, the solvent is an important component of the coating composition as it plays a critically important role in determining viscosity, film thickness, coating quality, and baking process parameters for effective solvent removal. The solvent content may depend on the coating method used, the desired coating thickness, and the properties of the finished coating product. The coating composition may contain solid content in a range between 10 percent by weight and 80 percent by weight of the composition, and in some applications, solvent content in a range between 20 percent by weight and 30 percent by weight of the composition to regulate viscosity.

As discussed above, radiation-curable hard-coat composition that includes a principal resin of multi-end-capped (meth)acrylate functionalized oligomers or polymers have a large molecular weight in a range between 500 and 20,000 and between 2 and 15 acrylate functional groups per molecule. When put in a solvent, the oligomers and polymers may potentially aggregate in micro scale due to the entanglement of random-coil chains of polymers. This presence of micro-aggregation results in inconsistencies in the coating quality and sacrifices optical quality giving rise to low transmission and high haze. A desirable solvent for the radiation-curable hard-coat composition includes the ability to dissolve coating resins under acceptable conditions for production, provide suitable coating quality, provide acceptable tolerance for manufacturing to a target film thickness based on the slope of viscosity versus solid content, and fast drying rate to ensure complete evaporation of solvent during the soft-bake phase. The soft-bake phase is the physical process between the deposition of the coating on a substrate and radiation curing in which a liquid-cast resin is converted to a relative solid film through solvent evaporation. In some cases, a temperature controlled oven channel may be employed to ensure the complete elimination of added solvents because any residual solvent may adversely affect the curing and the scratch resistance properties of the coating.

In one or more embodiments of the present invention, solvents that may optionally be used in the radiation-curable hard-coat composition may include, but are not limited to, ketone-type solvents (both acyclic ketones and cyclic ketones), such as acetone, methyl ethyl ketone, iso-butyl ethyl ketone and cyclopentanone, cyclohexanone, as well as alcohol-type solvents such as ethoxy ethanol, methoxy ethanol, and 1-methoxy-2-propanol. The use of cyclopentanone advantageously tends to minimize air bubbles trapped in the coating after application. In addition, the reduction of trapped air bubbles improves cross-linking induced during radiation curing. Air bubbles tend to contain approximately 21 percent oxygen by volume and the oxygen tends to quench the free radicals. Moreover, co-solvents of two or more solvents may be applied as the coating carrier. The large variety of solvents enables flexibility in tuning the viscosity of the radiation-curable hard-coat composition for various coating techniques including, for example, inkjet printing, spray coating, slot-die coating, dip-coating, curtain coating, gravure coating, and reverse-gravure coating. One of ordinary skill in the art will recognize that other coating techniques may be used in accordance with one or more embodiments of the present invention.

In one or more embodiments of the present invention, various combinations of the above-noted components may be used to create a radiation-curable hard-coat composition that exhibit different degrees of the various characteristics of the coating composition. While a few exemplary combinations are provided herein, one of ordinary skill in the art, having the benefit of this disclosure, will recognize that other combinations may be used in accordance with one or more embodiments of the present invention.

In certain embodiments, a radiation-curable hard coat composition may include a principal resin comprising multi-(meth)acrylate functionalized oligomers or polymers and a free radical-polymerization initiator comprising at least two photo-initiators in a predetermined ratio that generate a highly reactive species when irradiated with radiation. The principal resin may comprise aliphatic urethane acrylate content in a range between 5 percent and 90 percent as a percentage of weight of the composition and PETA content in a range between 0 percent and 70 percent as a percentage of weight of the composition. The free radical-polymerization initiator may comprise initiator content in a range between 1 percent and 5 percent as a percentage of weight of the composition to absorb shorter wavelengths, that has maximum absorption in a range between 200 nanometers and 300 nanometers such as, for example, 1-hydroxycyclohexyl phenyl ketone, and initiator content in a range between 0.5 percent and 4 percent as a percentage of weight of the composition to absorb longer wavelengths, that has absorption in a range between 300 nanometers and 420 nanometers, such as, for example, diphenyl(2,4,6-trimethylbenzoyl)phosphine oxide, where for the examples given, the predetermined ration is 4-to-1. In one or more embodiments of the present invention, the predetermined ratio of the first initiator to the second initiator is in a range between 5-to-1 and 2-to-1. A solvent comprising 1-methoxy-2-propanol content in a range between 10 percent and 80 percent as a percentage of weight of the composition. The coating composition was deposited on PMMA and PET substrates followed by UV radiation curing to achieve hard-coat films with a thickness ranging from 5 micrometers to 20 micrometers. The applied hard coat exhibited high pencil hardness (8H to 9H for PMMA substrate and 4H to 6H for PET substrate) with a loading of 750 grams based on ASTM D-3363 test, excellent abrasion resistance with no obvious scratch after 1000 cycles of steel-wool test with a loading of 750 grams based on ASTM F-2357 test, and excellent adhesion of 5B based on ASTM D-3359 test.

In other embodiments, a radiation-curable hard coat composition may include a principal resin comprising multi-(meth)acrylate functionalized oligomers or polymers and a free radical-polymerization initiator comprising at least two photo-initiators in a predetermined ratio that generate a highly reactive species when irradiated with radiation. The principal resin may comprise a hyperbranched polyester acrylate oligomer content in a range between 5 percent and 96 percent as a percentage of weight of the composition and PETA content in a range between 0 percent and 70 percent as a percentage of weight of the composition. The free radical-polymerization initiator may comprise initiator content in a range between 1 percent and 5 percent as a percentage of weight of the composition to absorb shorter wavelengths, that has maximum absorption in a range between 200 nanometers and 300 nanometers such as, for example, 1-hydroxycyclohexyl phenyl ketone and initiator content in a range between 0.5 percent and 4 percent as a percentage of weight of the composition to absorb longer wavelengths, that has absorption in a range between 300 nanometers and 420 nanometers, such as, for example, diphenyl(2,4,6-trimethylbenzoyl)phosphine oxide, where for the examples given, the predetermined ration is 4-to-1. In one or more embodiments of the present invention, the predetermined ratio of the first initiator to the second initiator is in a range between 5-to-1 and 2-to-1. A solvent comprising 1-methoxy-2-propanol content in a range between 10 percent and 80 percent as a percentage of weight of the composition. The coating composition was deposited on PMMA and PET substrates followed by UV radiation curing to achieve hard-coat films with a thickness ranging from 5 micrometers to 20 micrometers. The applied hard coat exhibited high pencil hardness (8H to 9H for PMMA substrate and 4H to 6H for PET substrate) with a loading of 750 grams based on ASTM D-3363 test, excellent abrasion resistance with no obvious scratch after 1000 cycles of steel-wool test with a loading of 750 grams based on ASTM F-2357 test, and excellent adhesion of 5B based on ASTM D-3359 test.

In still other embodiments, a radiation-curable hard coat composition may include a principal resin comprising multi-(meth)acrylate functionalized oligomers or polymers and a free radical-polymerization initiator comprising at least two photo-initiators in a predetermined ratio that generate a highly reactive species when irradiated with radiation. The principal resin may comprise aliphatic urethane acrylate content in a range between 5 percent and 90 percent as a percentage of weight of the composition and PETA content in a range between 0 percent and 70 percent as a percentage of weight of the composition. The free radical-polymerization initiator may comprise 1-hydroxycyclohexyl phenyl ketone content and diphenyl(2,4,6-trimethylbenzoyl)phosphine oxide content in a 1-to-1 ratio where each constitutes in a range between 1 percent and 4 percent as a percentage of weight of the composition. In one or more embodiments of the present invention, the predetermined ratio of the first initiator to the second initiator is in a range between 5-to-1 and 2-to-1. A solvent comprising 1-methoxy-2-propanol content in a range between 10 percent and 80 percent as a percentage of weight of the composition. The coating composition was deposited on PMMA and PET substrates followed by UV radiation curing to achieve hard-coat films with a thickness ranging from 5 micrometers to 20 micrometers. The applied hard coat exhibited high pencil hardness (4H to 7H for PMMA substrate and 2H to 4H for PET substrate) with a loading of 750 grams based on ASTM D-3363 test, excellent abrasion resistance with no obvious scratch after 1000 cycles of steel-wool test with a loading of 750 grams based on ASTM F-2357 test, and excellent adhesion of 5B based on ASTM D-3359 test.

Advantages of one or more embodiments of the present invention may include one or more of the following:

In one or more embodiments of the present invention, a radiation-curable hard-coat composition provides a hard-coat that is easy to apply, cures efficiently in a single UV irradiation cycle, provides improved flexibility and hardness, and provides improved process-ability for use in a manufacturing environment.

In one or more embodiments of the present invention, a radiation-curable hard-coat composition provides improved flexibility while maintaining a high degree of hardness and scratch and abrasion resistance.

In one or more embodiments of the present invention, a radiation-curable hard-coat composition reduces fragility and brittleness that reduces or eliminates undesirable breakage, cracking, and other failure modes that occur in post-fabrication processing of substrates with applied coatings.

In one or more embodiments of the present invention, a radiation-curable hard-coat composition reduces curling by lowering the built-in stress that significantly reduces the curling angle when the coating is applied to substrates with low mechanical strength, such as, for example, flexible PET substrates used in touch sensor applications.

In one or more embodiments of the present invention, a radiation-curable hard-coat composition includes a principal resin comprising multi-(meth)acrylate functionalized oligomers or polymers.

In one or more embodiments of the present invention, a radiation-curable hard-coat composition includes a principal resin comprising multi-(meth)acrylate functionalized oligomers or polymers that may be derived from various chemical backbones including, for example, polyol, polyester, polyurethane, polyether, epoxies, and acrylics.

In one or more embodiments of the present invention, a radiation-curable hard-coat composition includes a principal resin comprising multi-(meth)acrylate functionalized oligomers or polymers that may be linear or branched. Because of the skeleton of the resin backbone and the molecular geometry, these multi-(meth)acrylate functionalized oligomers or polymers are highly viscous in the liquid state.

In one or more embodiments of the present invention, a radiation-curable hard-coat composition includes a principal resin comprising multi-(meth)acrylate functionalized oligomers or polymers that, after curing, form a hard and rigid polymer with high tensile strength and modulus.

In one or more embodiments of the present invention, a radiation-curable hard-coat composition includes a principal resin comprising multi-(meth)acrylate functionalized oligomers or polymers that, after curing, exhibit a comparatively small shrinkage in volume that induces a low level of built-in stress and reduces the curling angle of the applied coating.

In one or more embodiments of the present invention, a radiation-curable hard-coat composition includes a multi-constituent photo-initiator comprised of at least two different photo-initiators.

In one or more embodiments of the present invention, a radiation-curable hard-coat composition includes a multi-constituent photo-initiator comprised of one or more surface curing agents and one or more deep curing agents that improve curing efficiency and provide homogenous curing along the depth of the applied coating

In one or more embodiments of the present invention, a radiation-curable hard-coat composition includes a multi-constituent photo-initiator that provides substantial absorption in a range between 200 nanometer and 480 nanometers.

In one or more embodiments of the present invention, a radiation-curable hard-coat composition includes a multi-constituent photo-initiator that minimizes spectral interference.

In one or more embodiments of the present invention, a radiation-curable hard-coat composition includes a multi-constituent photo-initiator that provides a high degree of photo-initiation efficiency in a single irradiation cycle.

In one or more embodiments of the present invention, a radiation-curable hard-coat composition includes a multi-constituent photo-initiator that allows for a high coating speed of up to 200 feet per minute in a high volume manufacturing environment with low defects, high yield, and excellent coating performance.

In one or more embodiments of the present invention, a radiation-curable hard-coat composition includes a solvent or co-solvents that prevent aggregation of the multi-(meth)acrylate functionalized oligomers or polymers in the micro scale.

In one or more embodiments of the present invention, a radiation-curable hard-coat composition includes a solvent or co-solvents that reduces or eliminates air bubbles that quench free radicals and reduce the optical performance of the coating.

In one or more embodiments of the present invention, a radiation-curable hard-coat composition provides improved optical performance including high transmission yield and low haze.

In one or more embodiments of the present invention, a radiation-curable hard-coat composition may be effectively applied using spray coating, slot-die coating, dip-coating, and reverse-gravure coating techniques.

While the present invention has been described with respect to the above-noted embodiments, those skilled in the art, having the benefit of this disclosure, will recognize that other embodiments may be devised that are within the scope of the invention as disclosed herein. Accordingly, the scope of the invention should be limited only by the appended claims.

What is claimed is:

1. A radiation-curable hard-coat composition comprising:
a principal resin comprising multi-(meth)acrylate functionalized oligomers or polymers; and
a free radical-polymerization initiator comprising at least two photo-initiators in a predetermined ratio that generate a highly reactive species when irradiated with radiation.

2. The composition of claim 1, where at least one multi-(meth)acrylate functionalized oligomers or polymers is at least 4 functional groups of the principal resin.

3. The composition of claim 1, wherein principal resin content as a percentage of weight of the composition is in a range between 5 percent and 96 percent.

4. The composition of claim 1, wherein free radical-polymerization initiator content as a percentage of weight of the composition is in a range between 2 percent and 8 percent.

5. The composition of claim 1, wherein free radical-polymerization initiator content as a percentage of weight of the composition is 4.5 percent.

6. The composition of claim 1, wherein the at least two photo-initiators comprise 1-hydroxycyclohexyl phenyl ketone and diphenyl(2,4,6-trimethylbenzoyl)phosphine oxide.

7. The composition of claim 6, wherein the predetermined ratio of 1-hydroxycyclohexyl phenyl ketone to diphenyl(2,4,6-trimethylbenzoyl)phosphine oxide is 3 to 1 by weight.

8. The composition of claim 6, wherein the predetermined ratio of 1-hydroxycyclohexyl phenyl ketone to diphenyl(2,4,6-trimethylbenzoyl)phosphine oxide is 4 to 1 by weight.

9. The composition of claim 1, wherein the at least two photo-initiators are selected to provide absorption in a range between 200 nanometer and 480 nanometers.

10. The composition of claim 1, wherein the at least two photo-initiators are selected to minimize spectral interference.

11. The composition of claim 1, wherein the at least two photo-initiators are selected to provide effective curing in a single UV irradiation cycle.

12. The composition of claim 1, wherein the mutli-(meth)acrylate functionalized oligomers or polymers are derived from a polyol backbone.

13. The composition of claim 1, wherein the mutli-(meth)acrylate functionalized oligomers or polymers are derived from a polyester backbone.

14. The composition of claim 1, wherein the mutli-(meth)acrylate functionalized oligomers or polymers are derived from a polyurethane backbone.

15. The composition of claim 1, wherein the mutli-(meth)acrylate functionalized oligomers or polymers are derived from a polyether backbone.

16. The composition of claim 1, wherein the mutli-(meth)acrylate functionalized oligomers or polymers are derived from an epoxy backbone.

17. The composition of claim 1, wherein the mutli-(meth)acrylate functionalized oligomers or polymers are derived from an acrylic backbone.

18. The composition of claim 1, wherein the at least two photo-initiators comprise one or more deep curing agents and one or more surface curing agents.

19. The composition of claim 1, further comprising a solvent.

20. The composition of claim 19, wherein the solvent comprises cyclopentanone.

21. The composition of claim 19, wherein solvent content as a percentage of weight of the composition is in a range between 10 percent and 90 percent.
